(19) United States
(12) Patent Application Publication
(10) Pub. No.: US 2022/0391522 A1
(43) Pub. Date: Dec. 8, 2022

(54) INTERNET ACCESS SYSTEM

(71) Applicant: Stark Technology Inc., Hsinchu (TW)

(72) Inventor: You-Cheng Jai, Hsinchu (TW)

(21) Appl. No.: 17/336,915

(22) Filed: Jun. 2, 2021

(51) Int. Cl. G06F 21/62

(52) U.S. Cl. CPC G06F 21/6218

(57) ABSTRACT

An internet access system includes a visitor, a database and a verification system. The verification system performs a verification procedure to the visitor, a result of the verification procedure and an internet signal feature of the visitor are recorded after passing the verification procedure, and the verification system outputs the access request and the internet signal feature to the database. The database sends a legal access verification request after receiving the access request and the internet signal feature, and the verification system performs a legal access verification procedure for checking whether the access request passes the verification procedure and whether the internet signal features in both the database and verification system are the same. The verification system allows the visitor to access the database after passing the legal access verification procedure and the internet signal feature of both the database and the verification system are the same.

### FIELD OF THE INVENTION

The present disclosure relates to an internet access system, and more particularly to an internet access system utilizing an internet signal feature as the verification function.

### BACKGROUND OF THE INVENTION

The prior internet access technologies set up a verification system between the visitor and the database. Therefore, when a visitor attempts to access the database, the verification system will first verify the identity of the visitor to ensure that the visitor has a legal identity to access the database. Thereby, the security of the contents of the database is protected.

However, the complexity level of the verification mechanism design for the verification system directly affects the security of the database, and the safety of the database cannot be completely guaranteed through the verification system. Therefore, when the verification mechanism is cracked by hackers or is abnormal during operation, the contents of the database may be tampered or stolen without the knowledge of the owner of the database.

Therefore, there is a need of providing an internet access system to obviate the drawbacks encountered from the prior arts.

### SUMMARY OF THE INVENTION

It is an object of the present disclosure to provide an internet access system, and the internet access system utilizes an internet signal feature as the verification function to enhance the security of the database. Therefore, the security of the database is improved, and the internet access system has a high degree of credibility and safety.

In accordance with an aspect of the present disclosure, there is provided an internet access system. An internet access system includes a visitor, a database and a verification system, and the verification system is connected between the visitor and the database. The verification system performs a verification procedure to the visitor when the visitor sends an access request to the verification system. After passing the verification procedure, a result of the verification procedure and an internet signal feature of the visitor are recorded in the verification system, and the verification system outputs the access request to the database. The database sends a legal access verification request to the verification system after receiving the access request, and the verification system performs a legal access verification procedure for checking whether the access request sent by the visitor passes the verification procedure and whether the internet signal feature recorded in the database are consistent with the internet signal feature recorded in the verification system. The verification system allows the visitor to access the database after both passing the legal access verification procedure and realizing that the internet signal features of the database and the verification system are consistent with each other.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating an internet access system 1 according to an embodiment of the present disclosure; and

FIG. 2 is a schematic diagram illustrating the signal transmission of the internet access system 1 according the embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

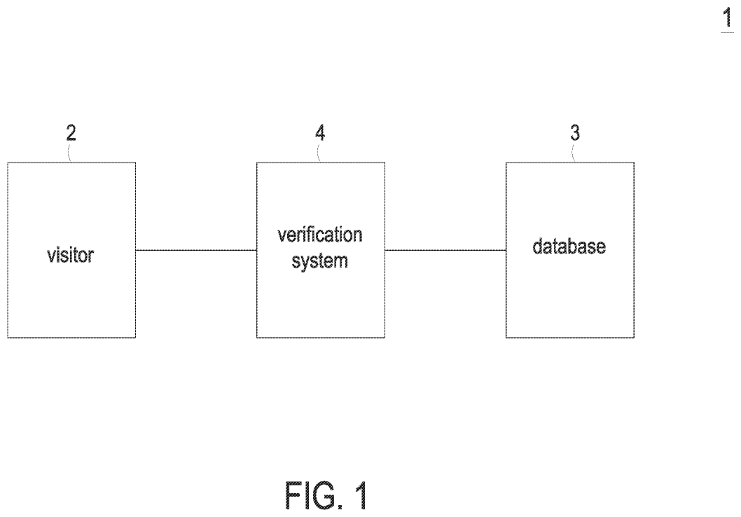

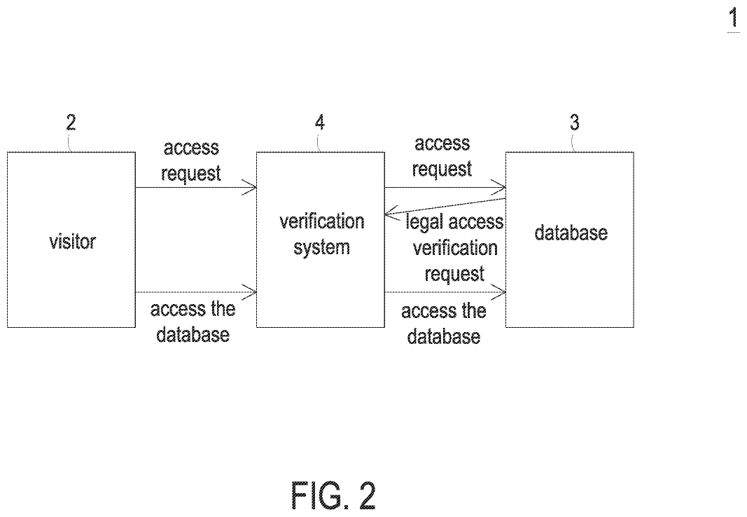

FIG. 1 is a schematic circuit diagram illustrating an internet access system 1 according to an embodiment of the present disclosure. FIG. 2 is a schematic diagram illustrating the signal transmission of the internet access system 1 according to the embodiment of the present disclosure. As shown in FIGS. 1 and 2, the internet access system 1 includes a visitor 2, a database 3 and a verification system 4. The verification system 4 is connected between the visitor 2 and the database 3. The verification system 4 performs a verification procedure to the visitor 2 when the visitor 2 sends an access request to the verification system 4. After passing the verification procedure, a result of the verification procedure and an internet signal feature of the visitor 2 are recorded in the verification system 4, and the verification system 4 outputs the access request to the database 3.

The database 3 sends a legal access verification request to the verification system 4 after receiving the access request. The verification system 4 performs a legal access verification procedure for checking whether the access request sent by the visitor 2 passes the verification procedure and whether the internet signal feature recorded in the database 3(the internet signal feature is pre-recorded in the database 3) are consistent with the internet signal feature recorded in the verification system 4.

The verification system 4 allows the visitor 2 to access the database 3 after both passing the legal access verification procedure and realizing that the internet signal features recorded in database 3 and the verification system 4 are consistent with each other.

The internet access system 1 of the present disclosure utilizes an internet signal feature as the verification function to enhance the security of the database. Therefore, the security of the database is improved, and the internet access system has a high degree of credibility and safety.

For example, the internet signal feature includes at least one of the phone numbers, the Internet Protocol (IP Address) Address or the Media Access Control Address (MAC Address).

In an embodiment, the phone numbers of the visitor 2 is utilized as the internet signal feature for verification. The verification system 4 performs a legal access verification procedure for checking whether the access request sent by the visitor 2 passes the verification procedure and whether the phone numbers of the visitor 2 recorded in the database 3 are the same as the phone numbers of the visitor 2 recorded in the verification system 4. The verification is passed when both checking results are satisfied.

In an embodiment, the Internet Protocol Address of the visitor 2 is utilized as the internet feature for verification. The verification system 4 performs a legal access verification procedure for checking whether the access request sent by the visitor 2 passes the verification procedure and whether the Internet Protocol Address of the visitor 2 recorded in the database 3 are the same as the Internet Protocol Address of the visitor 2 recorded in the verification system 4.

In an embodiment, the Media Access Control Address of the visitor 2 is utilized as the internet feature for verification. The verification system 4 performs a legal access verification procedure for checking whether the access request sent by the visitor 2 passes the verification procedure and whether the Media Access Control Address of the visitor 2 recorded in the database 3 are the same as the Media Access Control Address of the visitor 2 recorded in the verification system 4.

From the above descriptions, the present disclosure provides an internet access system, the internet access system utilizes an internet signal feature as the verification function to enhance the security of the database. Therefore, the security of the database is improved, and the internet access system has a high degree of credibility and safety.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An internet access system, comprising a visitor, a database and a verification system, wherein the verification system is connected between the visitor and the database,
wherein the verification system performs a verification procedure to the visitor when the visitor sends an access request to the verification system, after passing the verification procedure, a result of the verification procedure and an internet signal feature of the visitor are recorded in the verification system, and the verification system outputs the access request to the database,
wherein the database sends a legal access verification request to the verification system after receiving the access request, and the verification system performs a legal access verification procedure for checking whether the access request sent by the visitor passes the verification procedure and whether the internet signal feature recorded in the database are consistent with the internet signal feature recorded in the verification system,
wherein the verification system allows the visitor to access the database after both passing the legal access verification procedure and realizing that the internet signal features recorded in the database and the verification system are consistent with each other.

2. The internet access system according to claim 1, wherein the internet signal feature comprises the phone numbers.

3. The internet access system according to claim 1, wherein the internet signal feature comprises the Internet Protocol Address.

4. The internet access system according to claim 1, wherein the internet signal feature comprises the Media Access Control Address.
